(19) United States
(12) Patent Application Publication
(10) Pub. No.: US 2023/0353373 A1
(43) Pub. Date: Nov. 2, 2023

(54) SYSTEM AND METHOD FOR CREATING A PERSISTENT DIRECTORY SIGNATURE FILE

(71) Applicants: Kelsey L Bruso, Minneapolis, MN (US); Brian A. Wegleitner, Eagan, MN (US); Michael T. Kain, Blue Bell, PA (US)

(72) Inventors: Kelsey L Bruso, Minneapolis, MN (US); Brian A. Wegleitner, Eagan, MN (US); Michael T. Kain, Blue Bell, PA (US)

(73) Assignee: Unisys Corporation, Blue Bell, PA (US)

(21) Appl. No.: 17/734,947

(22) Filed: May 2, 2022

(51) Int. Cl. H04L 9/32

(52) U.S. Cl. CPC H04L 9/3236

(57) ABSTRACT

A processor-based method for creating a persistent directory signature file, comprising: selecting a private key, a certificate identifier and a hash algorithm identifier for the directory signature file; concatenating one or more persistent, independent signatures wherein a persistent independent signature includes a file name, sub-directory indicator, or meta-data indicator, and a certificate identifier, and a hash identifier, and an encrypted hash; creating an encrypted hash of the one or more concatenated signatures using the hash algorithm and private key chosen for the directory signature file; and concatenating the encrypted hash of the one or more concatenated signatures with the concatenated signatures and the certificate identifier, and hash algorithm identifier chosen for the directory signature file to create a persistent, independent signature for the directory signature file. A persistent directory signature file includes a directory signature file certificate identifier; a directory signature file hash identifier; a file name; a file certificate identifier; a file hash identifier; a file hash value encrypted; and a directory signature file hash value encrypted.

### FIELD OF THE DISCLOSURE

The present invention relates generally to file-based digital signatures. More particularly, the present invention includes specifically designed signature creation and verification structure and methods to more securely ensure authentic software, files, and directories.

### BACKGROUND

The integrity of the supply chain from software creators, to installers, to users is vital to computer and software security. Many software files utilize an appended or embedded signature and user certificate to validate the signature. But usually, only files which are executable on the user's system benefit from this process. Since many more types of files than this are often included by creators and may be modified by installers, malware, ransomware, and others, a need for ensuring authenticity of all files, especially those presently unsecured files and other digital items exists.

### SUMMARY

Software often includes not only executable files but also configuration files, scripts, descriptive text files, installation video, and other files some of which are human-readable, and others of which are encoded in a non-human-readable form, such as audio or video files. The present invention provides a mechanism to create verifiable signatures for a set or directory of files of mixed types. The disclosed systems and methods can individually sign all file types, including text files, configuration files, and media files, including those files that can be executed and those that direct the execution. Meta-data from individual files and directories can also be signed.

In some embodiments, a digital signature is created for each file. In other embodiments, a digital signature is created for meta-data associated with each file. A signature for a digital item involves creating a hash for the item's contents and then encrypting the hash using a private key. To the encrypted hash, the identifier for the hash technique used to create the hash value, the name of the certificate containing the corresponding public key, and additional information are added, comprising the signature. The signature may also have other attributes.

Some embodiments combine multiple files into one assembly and a digital signature is created for that assembly. Meta-data associated with multiple files may be aggregately signed as well.

In other embodiments, signatures are created for a mixed group of files and sub-directories and the associated metadata for each file or for the sub-directory itself. Sub-directories may be processed into assemblies and signatures created for them, or a signature directory file may be created for the sub-directory and its contents. In these embodiments, a signature directory file is created which contains all the signatures for a selected directory and a user or installer can then verify the contents' authenticity or detect changes that have occurred since the contents were created and signed.

In one aspect of the present invention, a processor-based method for creating a persistent directory signature file, comprising: selecting a private key, a certificate identifier and a hash algorithm identifier for the directory signature file; concatenating one or more persistent, independent signatures wherein a persistent independent signature includes a file name, sub-directory indicator, or meta-data indicator, and a certificate identifier, and a hash identifier, and an encrypted hash; creating an encrypted hash of the one or more concatenated signatures using the hash algorithm and private key chosen for the directory signature file; and concatenating the encrypted hash of the one or more concatenated signatures with the concatenated signatures and the certificate identifier, and hash algorithm identifier chosen for the directory signature file to create a persistent, independent signature for the directory signature file.

In a second aspect of the present invention, a computer program product including a non-transitory computer readable medium comprising instructions which, when executed by a processor of a computing system, cause the processor to perform the steps of: selecting a private key, a certificate identifier and a hash algorithm identifier for the directory signature file; concatenating one or more persistent, independent signatures wherein a persistent independent signature includes a file name, sub-directory indicator, or meta-data indicator, and a certificate identifier, and a hash identifier, and an encrypted hash; creating an encrypted hash of the one or more concatenated signatures using the hash algorithm and private key chosen for the directory signature file; and concatenating the encrypted hash of the one or more concatenated signatures with the concatenated signatures and the certificate identifier, and hash algorithm identifier chosen for the directory signature file to create a persistent, independent signature for the directory signature file.

In a third aspect of the present invention, a persistent directory signature file includes a directory signature file certificate identifier; a directory signature file hash identifier; a file name; a file certificate identifier; a file hash identifier; a file hash value encrypted; and a directory signature file hash value encrypted.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a schematic figure of a system for creating a verifiable file signature.

FIG. 2 is schematic figure of a system for creating a verifiable signature for an assembly of files.

FIG. 3 is a schematic figure of a system including an embodiment of the invention.

FIG. 4A is a schematic figure of a process for creating an independent signature for a file.

FIG. 4B is a schematic figure of creating an independent signature for meta-data.

FIG. 4C is a schematic figure of example content included in an independent signature for a file.

FIG. 4D is a schematic figure of example content included in an independent signature for meta-data of a file.

FIG. 4E is a schematic figure of example content included in an independent signature for a file and meta-data of that file.

FIG. 4F is a schematic figure of example content included in an independent signature for meta-data of a sub-directory.

FIG. 4G is a schematic figure of example content included in an independent signature for meta-data of a sub-directory.

FIG. 4H is a schematic figure of example content included in an independent signature for a sub-directory.

FIG. 5 is a schematic figure of a system for creating an assembly which may consist of files, sub-directories, or both to be signed.

FIG. 6 is a schematic figure of a process for creating a directory signature file.

FIG. 7 is a schematic figure of content included in an example directory signature file.

FIG. 8 is a schematic figure of a process for verifying an example file using a directory signature file.

FIG. 9 is a block diagram illustrating a computer network according to one embodiment of the disclosure.

FIG. 10 is a block diagram illustrating a computer system according to one embodiment of the disclosure.

FIG. 11 is a flow diagram of a method for securing files through a persistent signature, according to one example embodiment.

FIG. 12 is a flow diagram of a method for securing files through a persistent signature for file meta-data, according to another example embodiment.

FIG. 13 is a flow diagram of a method for securing a directory through a persistent signature according to another example embodiment.

FIG. 14 is a flow diagram of a method for verifying a file, directory, or meta-data with a persistent signature and directory signature file according to another example embodiment.

FIG. 15 is a flow diagram of a method for securing files through a directory signature file according to another example embodiment.

### DETAILED DESCRIPTION

In general, the present invention discloses techniques for creating a digital signature for a file, a set of files, sub-directories and/or meta data for files or subdirectories. The creator or originator of the digital signature can choose from which set to create a digital signature, using a private key, certificate identifier and a hash algorithm identifier. Including subdirectories or meta data in the digital signature provides another level of security as to authenticity of the file or assembled file.

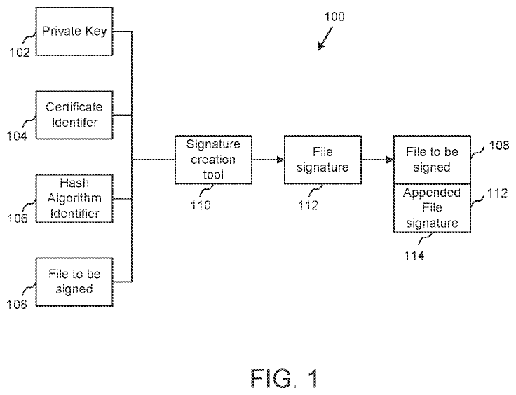

FIG. 1 is a schematic diagram of a general process for signing a file 108 with a signature 112 including choosing a private key 102, a certificate identifier 104, and a hash algorithm identifier 106. In this example, a signature creation tool 110 uses the private key 102, certificate identifier 104 and the hash algorithm identifier 106 to create a file signature 112. The file signature 112 is appended to the file 108, resulting in a signed file 114. The certificate identifier 104 can be used to identify a certificate that a user or installer can use to verify the signed file 114.

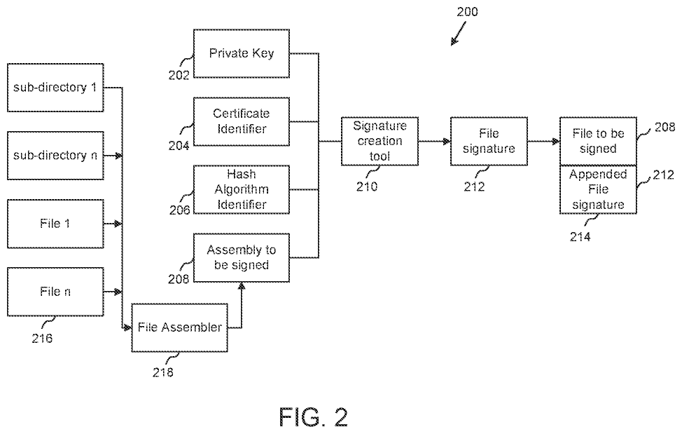

FIG. 2 shows a schematic diagram of a system for signing a set of files 216 (File 1 . . . File n) using a file assembler 218 to create an assembly 208. The assembly 208 may be a “zip” file, a “cab” file, a “tar” file, or similar assembly of multiple files. A signature creation tool 210 uses a private key 202, a certificate identifier 204, and a hash algorithm identifier 206 to create a signed file 214 with appended file signature 212.

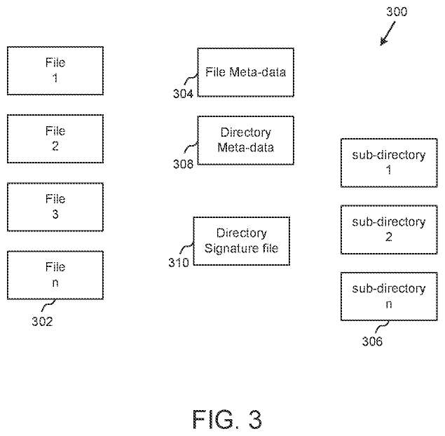

FIG. 3 shows a selected directory 300 schematically, according to one example embodiment. The disclosed invention enables and supports signing and verifying all types of files 302 (File 1 . . . File n) and sub-directories 306 (sub-directory 1 . . . sub-directory n) discretely. Although the invention applies equally to any file 302 and sub-directory 306 set, in practical terms, all files and directories in a hierarchical file system appear within a directory. As an example, for the following description, the selected directory 300 refers to the set of files 302 and sub-directories 306 that may include one or more files 302 that can be of any type: executable files, text files, configuration files, media files, and so on, and zero or more signed sub-directories 306, along with file meta-data 304, directory meta-data 308, and a directory signature file 310.

The directory contains meta-data 304 describing each file 302, such as the name of the file, a timestamp for when the file was created, who created the file, security attributes such as read, write, and execute, a timestamp for the last reference to the file, and so on. The selected directory contains zero or more sub-directories 306. Directory meta-data 308 likewise describes each sub-directory 306 with information similar to the file meta-data 304. Preferably, the present invention includes a creation of a directory signature file 310 for the selected directory, which can be used to detect any tampering with the files 302, sub-directories 306, file meta-data 304 or directory meta-data 308 of the selected directory 300.

For the present disclosure, files of any type, directories, assemblies of files and directories, meta-data for files, meta-data for directories, aggregate meta-data or their equivalents are all examples that may be verifiably secured by the present invention's systems and methods employing persistent independent signatures and a directory therefor. The disclosed system and methods allow for benefits in any hierarchical file system or flat file system. Examples of types of files included, are non-executable files and non-assembled files, configuration text files, read.me text files, structured files such as MP3 audio files or MP4 video files, and other types of files for which no signing process previously exists.

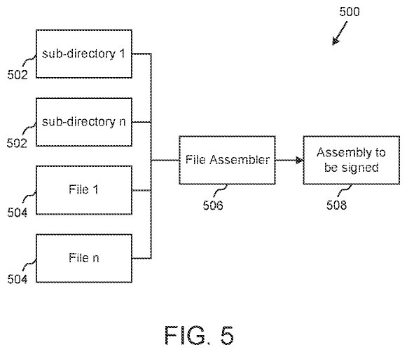

For the present disclosure, an originator refers to the person or organization who acts on or processes the original set of files or directories and uses the tools, e.g. a signature creation tool 410 described below, to create a signature for the set of files or selected directory. An originator chooses the selected directory 300 containing one or more files 302, zero or more sub-directories 306, file meta-data 304, and directory meta-data 308. The originator uses the processes described in FIGS. 3-8 to create a directory signature file 310 and to insert it into the selected directory 300. The originator chooses to include or exclude files 302 or sub-directories 306 in the directory signature file 310. The originator chooses to include or exclude file meta-data 304 and directory meta-data 308 in the directory signature file 310. The originator chooses the technique to use to sign each sub-directory 306 as discussed further below in reference to FIG. 5 and surrounding descriptions. The result of the originator's actions is a signed file and directory set.

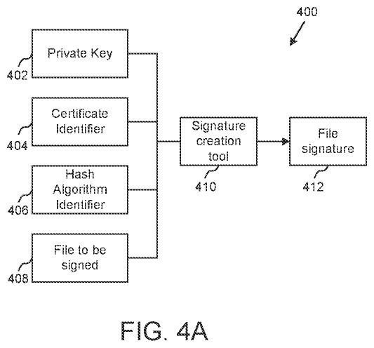

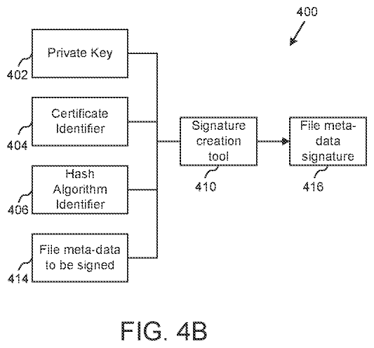

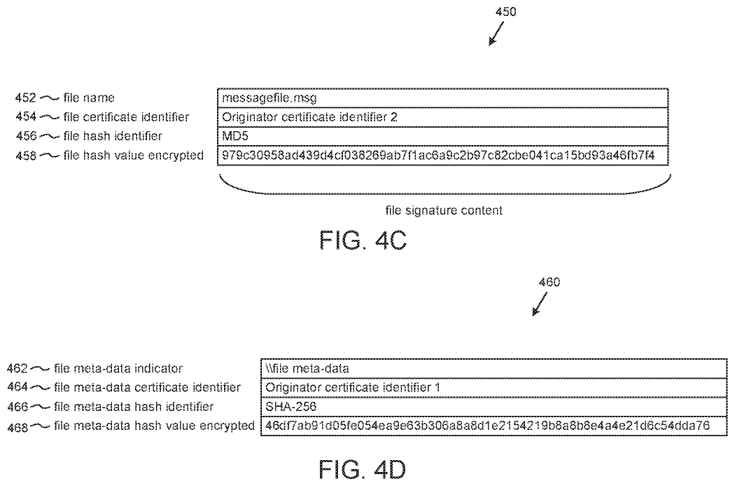

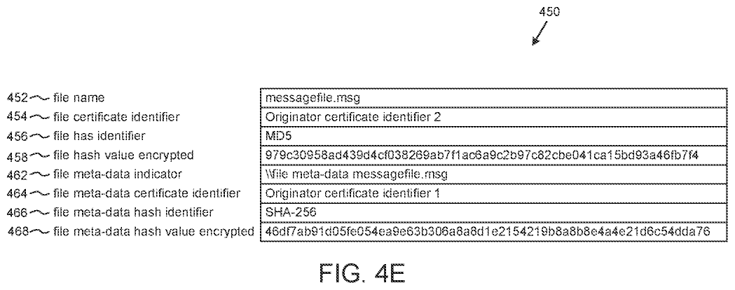

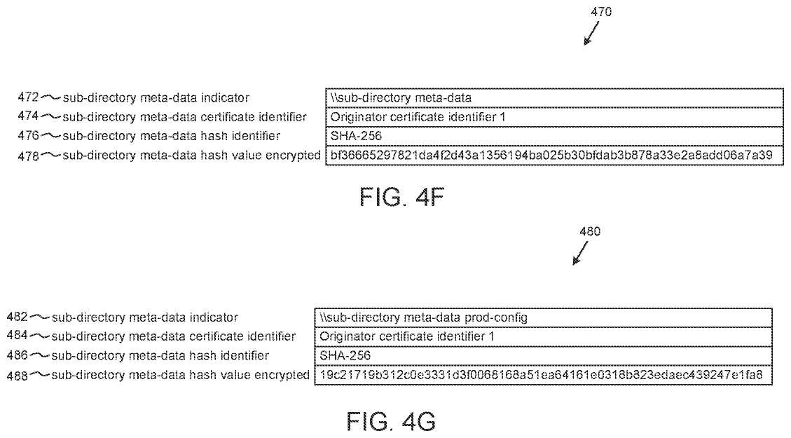

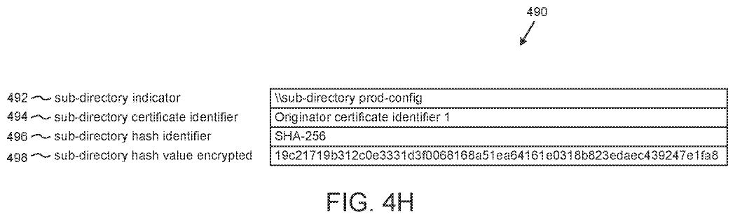

Referring to FIG. 4A, a method 400 for creating a signature 412 is shown in an embodiment schematically. The signature 412 is an independent, persistent object. A signature creation tool 410 can be used by the originator to create the signature 412. The process 400 can be used to create a signature 412 for a file or set of files, or a sub-directory, or a set of sub-directories. A set of files may be given a file name and the signature would correspond to the set, which may be an assembly of files or sub-directories as described in FIG. 5.

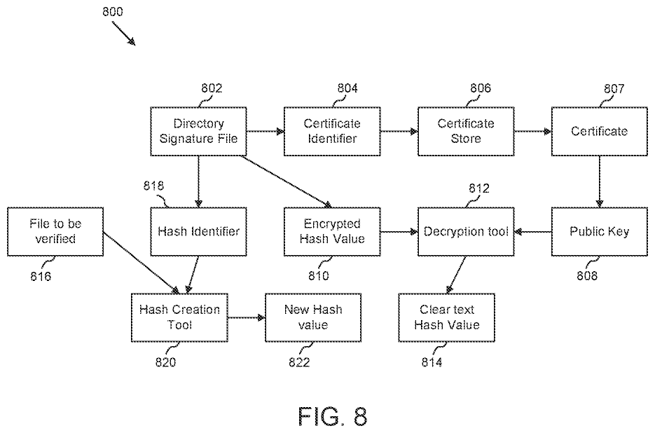

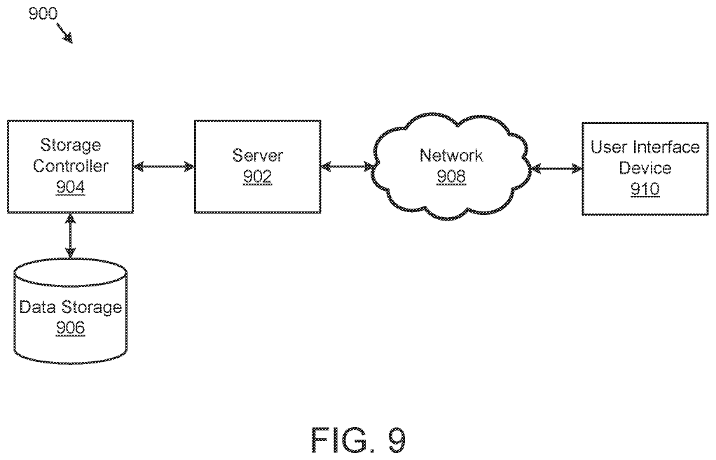

Creating a persistent, independent file signature 412, in one embodiment for a file 408, involves creating a hash for the file's contents and then encrypting the hash using a private key 402 chosen or created for that file 408 by the originator. To the encrypted hash, the identifier for the hash technique 406 used to create the hash value and the name of the certificate 404 containing the corresponding public key are added and can include additional information. The originator can choose a different private key 402 and certificate identifier 404 which pair the private key 402 to a public key 808 (FIG. 8) and tie it to an identity, e.g. the file 408, and/or hash algorithm 406 for each file 408 to be signed. The result for each is a persistent file signature 412. The signature may also have other attributes. The signature 412 is not appended to the file but exists independently of the signed file 408. The signature 412 is used in additional processes described below.

The originator may wish to differentiate among the various kinds or purposes of the files, for example, files which can be executed, files which contain configuration information, and files which are documentation, e.g. read.me files, or any text files. In this situation, the originator may choose a specific private key 402 and certificate identifier 404 pair and hash algorithm identifier 406 for each identified kind or purpose of a file. The certificate identifier 404 most often will uniquely identify a certificate, shown in FIG. 8 as 807, in the user's certificate store, shown in FIG. 8 as 806. A certificate may be otherwise available from the originator or an installer, for example from a website. The certificate would be accessible to a user, for example in the user's certificate store 806, when the processing associated with FIG. 8 is performed.

In FIG. 4B, a file meta-data signature 416 is created in an embodiment shown schematically. An originator may use the invention to sign meta-data in more than one way. The originator may choose or create a particular private key 402 and certificate identifier 404 pair with a hash algorithm identifier 406 as described for FIG. 4A. In one embodiment, the process 400 treats all file meta-data 408 as a set and creates one meta-data signature 416 for the selected directory 300. In another embodiment each file's meta-data 408 has a corresponding meta-data signature 416. In other embodiments, subsets or aggregates of meta-data may be given file meta-data signatures 416.

When executing the processes of FIGS. 4A and 4B, the originator may choose: a single private key 402, a certificate identifier 404, and a hash algorithm 406 to use for all files 408 and file meta-data 414, or a different set of 402, 404, and 406 for each kind of file or file set (consisting of 1-n files, where n may be any number). For example, one set of a key 402, identifier 404, and hash algorithm 406 can be used for executable files 408 and a different set used for configuration files 408, and so on. A different set can be used for each file 408 and for each file meta-data 414 in the selected directory 300 and to create a meta-data signature corresponding to each chosen file, to create a meta-data signature for all file meta-data, to create a meta-data signature for each sub-directory, and/or to create a meta-data signature for all sub-directories.

For the present disclosure, an installer refers to a person or organization and associated tooling who receives the signed file 302 and sub-directory 306 set shown in FIG. 3 and performs the process described in FIG. 8 to validate its contents. The installer may modify configuration files or other files in the signed file 302 and sub-directory 306 set. The installer may create additional files to add to the signed file and sub-directory set. The installer uses the process 800 of FIG. 8 to ensure the validity of the directory signature file 310 and the other content of the selected directory.

In one embodiment, the processing 800 of FIG. 8 verifies all items in the selected directory and in any sub-directories and nested sub-directories. In a second embodiment, the installer chooses the items to be verified. In a third embodiment, the processing 800 disassembles any assembled files after verifying them. In some cases, the installer modifies one or more files in the selected directory, for example a configuration file. The installer might also modify the content of the selected directory (signed file and sub-directory set) by adding one or more files or sub-directories to the set. After modifying the file or sub-directory, the installer performs the originator actions and uses the processes described in FIGS. 3-7 to create a new signature for each modified or added file or directory. The installer uses a private key, certificate identifier, and hash algorithm identifier different from those used by the originator. The processes described in FIGS. 3-8 replace the prior signatures for the modified files and directories with new signatures. The signatures for any unmodified files and directories remain as they were when created by the originator. The processes create a new directory signature file 310 containing the original and new signatures. The result of these installer actions is a re-signed file and sub-directory set. The original signatures would indicate that the files were authenticated by the originator and the new signatures would indicate that the files were modified by the installer and authenticated by the installer.

For the present disclosure, a loader or user is the person or organization and associated tooling who cause the software to initiate execution. The loader uses process 800 to ensure the validity of the signed file and directory set or re-signed file and directory set. As an example, a certificate store may identify a list of trusted signers, which allows for verification of certificates and proper use of public keys in the validation process for digital signatures. Any changes made by the installer and re-signed by the installer are verified during this process.

In FIGS. 4C-4H, exemplary file, meta-data, and sub-directory signatures are described with sample structure and content. The invention may be used to create a signature file for a particular file, e.g. an email shown with file name 452 messagefile.msg. Signatures disclosed that are created for a particular file may include signature content 450 including the file name 452, the chosen file certificate identifier 454, a file hash identifier 456, and the encrypted file hash value 458 that is the unique portion of the signature. File name 452 identifies the signed file 408 associated with the signature 412. The file certificate identifier 454 corresponds to the certificate identifier 404 chosen or created for the file 408. Similarly, the file hash identifier 456 corresponds to the hash algorithm identifier 406 for the hashing mechanism used to create the hash value for the file 408. Example hash mechanisms include SHA-1 and SHA-256. An encryption mechanism is used to encrypt the hash value using private key 402 creating the file hash value encrypted 458 that is the unique portion of the signature. As an example, file hash value encrypted 458 is represented in Base64.

In FIG. 4D, similar sample signature content 460 for aggregate file meta-data is shown, using file meta-data 414 instead of file 408. In FIG. 4E, the meta-data 414 for each particular file 408 is signed. As an example, the file meta-data indicator 462 may identify the file 408 associated with the metadata 414 and the signature 416 content 450 may include information 452-468 for both the file 408 and the meta-data 414. In FIGS. 4F-4H, sub-directory signatures 412 created using process 400 are described. One signature may be created for all meta-data for sub-directories in the selected directory 300 as shown in signature content 470. In other embodiments, a signature may be created for each sub-directory's meta-data as in FIG. 4G where the sub-directory meta-data indicator 482 shows an exemplary particular sub-directory included in the signature content 480. Additionally, signatures may be created for each sub-directory or sub-directories as an assembly, discussed further below. In FIG. 4H a signature for a particular sub-directory is identified with sub-directory indicator 492 included in the signature content 490.

In FIG. 5, a method 500 for an assembly to be signed 508 is created in an embodiment shown schematically from sub-directory 306 of FIG. 3 chosen from the selected directory 300 (FIG. 3) that may include further sub-directories 502 and files 504 using a file assembler 506. The assembly 508 may include sub-directories 502, or files 504 of mixed types, or a combination of both, and a signature for the assembly 508 can be created with process 400 and/or for the meta-data associated with the assembly 508 as discussed in reference to FIGS. 4A and 4B.

For sub-directories, signatures may be created in more than one way depending on the desired level of detail to be contained in the signature. As discussed for FIG. 4A and FIG. 5, the contents of a sub-directory 306 (FIG. 3) contained in the selected directory 300 (FIG. 3), may be processed into an assembly 508, and then a signature may be created as for a file 408. If sub-directory 308 (FIG. 3) contains nested sub-directories 502, the process 500 may be repeated for each sub-directory 502 until a single assembly 508 is created. A single signature may be created for the assembly 508 as shown in FIG. 4H. Alternatively, a second signature may be created for the meta-data of the assembly 508 as discussed in reference to FIG. 4B and shown in FIGS. 4F and 4G. In FIG. 5, the assembled file 508 replaces the chosen sub-directory 306 as a new file instance 302. Creating the signature for this new file follows the process described in FIG. 4A.

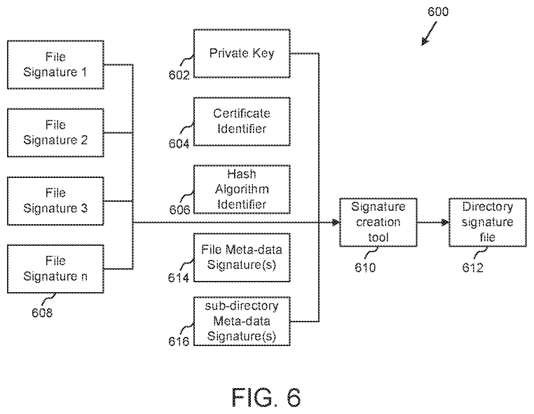

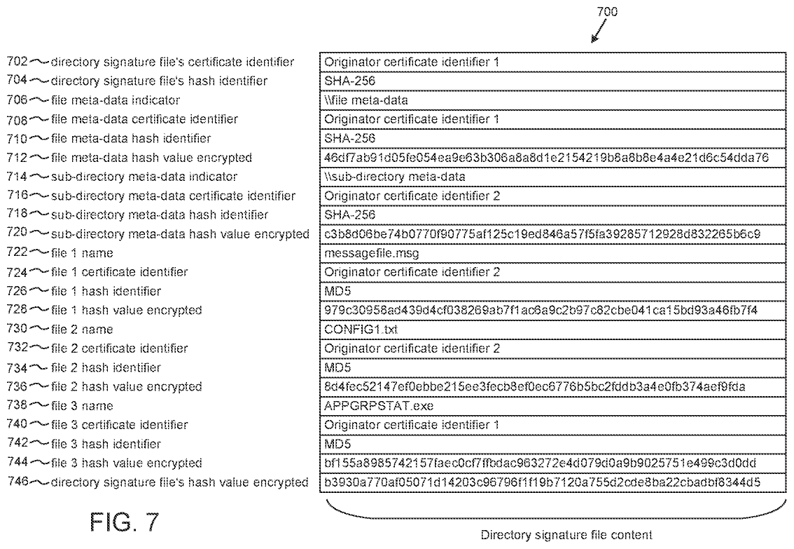

If desired, the technique 600 discussed and schematically shown in FIG. 6 may be used to create a directory signature file 612 for a chosen sub-directory 306 (FIG. 3). If sub-directory 306 (FIG. 3) contains nested sub-directories 502 (FIG. 5), the originator may choose to create assemblies 508 (FIG. 5) or to create additional directory signature files 612 as discussed further below for FIG. 6. Using this technique of directory signature files 612, signatures may be created that include signatures for the content of the sub-directory and for the meta-data of each selected sub-directory as discussed in FIGS. 4F-4G. Such meta-data includes, for example, the sub-directory name, access control attributes, creation date, and so on, which is contained in the signature in the same manner as the rows of information are shown in FIGS. 4F-4H, with an example showing the additional layers that can be contained in one signature in FIG. 7, discussed further below.

Additionally, the originator may wish to differentiate among the various kinds or purposes of sub-directories, for example, sub-directories which contain files that can be executed, sub-directories that contain configuration information files, and sub-directories that contain documentation. In this situation, the originator may choose a specific private key 602 and certificate identifier 604 pair and hash algorithm identifier 606 for each identified kind or purpose of subdirectory.

In FIG. 6, a process is shown schematically for creating a directory signature file 612 for all files or sub-directories 408 (FIG. 4), file meta-data 414 (FIG. 4), and sub-directory meta-data for which signatures have been created 608, 614, 616. The originator may again choose or create each of a private key 602 and certificate identifier 604 pair, and hash algorithm identifier 606 to create a persistent signature for all the selected directory's signatures having been created, including file signatures 608, file meta-data signatures 614, and sub-directory meta-data signatures 616. Any sub-directories processed into assemblies as discussed with FIG. 5, would have file signatures 608.

With the chosen inputs 602-608, 612-616, the originator uses signature creation tool 610 to create the directory signature file 612, which is then placed in the selected directory 300 (FIG. 3) as the directory signature file 310 (FIG. 3). A signature creation tool 610 concatenates the certificate identifier 604, the hash algorithm identifier 606, the file signatures 608, the file meta-data signatures 614, and the sub-directory meta-data signatures 616. These inputs are hashed according to the hash algorithm as identified by the hash algorithm identifier 606. The hash value is encrypted using a private key 602. This encrypted hash is concatenated to the previously concatenated contents for the directory signature file 612.

Referring to FIG. 7, the content of an example directory signature file 700 is shown, as human readable text. This example directory signature file 700 contains individual file signatures for three files: messagefile.msg (722-728), CONFIGI.txt (730-736), and APPGPRSTAT.exe (738-744). Each signature was created using the process described with FIG. 4A. The directory signature file 700 contains one signature for the selected directory's file meta-data (706-712) created using the process described with FIG. 4B. It also contains one signature for the sub-directory meta-data (714-720) created using the process described with FIG. 4B. The originator chose to sign each sub-directory, as discussed above; thus the signature for the sub-directory meta-data was created. The directory signature file's 700 certificate identifier 702 carries forward certificate identifier 604. The directory signature file's hash identifier 704 carries forward hash algorithm identifier 606 (FIG. 6).

The signature creation tool 610 (FIG. 6) concatenates the values 702 through 744 into a single string. It uses a hash mechanism and hash algorithm identifier 606 (FIG. 6) to create a hash value for this string. It uses an encryption mechanism and private key 602 (FIG. 6) to create a directory signature file's hash value encrypted 746. In one embodiment, the encrypted hash value 746 is a Base64 encoding of the encrypted hash. The set of items 702 through 746 becomes the content for the directory signature file 310 (FIG. 3) in the selected directory 300 (FIG. 3).

Each kind of file system creates and maintains different meta-data about its files and directories. Some meta-data attributes can be created or changed by users—such as the name of the file; name of the directory; read, write, or execute restricted access to a file; read or write restricted access to a directory; a list of users, roles, or other characteristics who can perform the restricted access to a file or directory, sometimes maintained as an “Access Control List”; whether a file is an executable file or not; and so on. Other file and directory meta-data attributes can only be set or changed by the file system itself, such as timestamps for creation, last reference, last modification, last backup, and other timestamps. Some file systems set the meta-data attribute to indicate a file is executable at file creation time. Some file systems set the read, write, and execute meta-data attributes at file creation or directory creation time. These meta-data attributes typically are either unalterable or can only be changed by the user who created the file or by a privileged user. Some meta-data changes can have significant impact on a product and its security. For example, changing the executable attribute of a file can make it unusable or can make a previously non-executable file into a malicious executable. Adding a write access meta-data attribute to a file or directory immediately compromises its security. By creating a signature for meta-data, the verification process in FIG. 8 can detect if any meta-data attributes have been changed, ensuring security to a higher level than prior signature and certificate systems.

For signing and verification purposes as described in the present invention, FIGS. 4A and 4C may be referred to as an example embodiment, though the process applies more broadly including meta-data, sub-directories, and assemblies of files and sub-directories as described above, including for FIGS. 4A-H and 5.

Turning to FIG. 8, a system and method for verification of a file's signature is shown schematically. Referring also to FIGS. 4A and 4C, the file to be verified 816 has a signature created with a private key 402 which is a closely held secret, known to the originator who created a signature 412 for the file 408, 816. The originator uses the private key 402 to encrypt a text, as an example, a hash value to obtain the encrypted hash value 458 at the time of creation or signing the file.

The public key 808 is widely known and widely available to recipients of the signed file 408, 816. The public key 808 is part of a certificate 807 that can be downloaded from a company's website or retrieved from an installer's or user's certificate store 806, or a certificate 807 may point to the public key's 808 location. Certificates are trusted bindings of public key 808 to identity of the signed file 816. Here, certificate store 806 is a list of trusted signers which can verify that a user's certificate 807 is valid and identify the public key 808 paired with the private key 402 (FIG. 4A) tied to the file 408, 816. The private key 402 and public key 808 form a pair and are the basis for asymmetric encryption algorithms such as RSA, DSA, and ECC (Elliptic Curve Cryptography). One key, the private key 402, is used to encrypt a text. The other key, a public key 808, is used to decrypt the text. A certificate 807 either contains the public key 808 corresponding to the private key 402 used to encrypt the hash in the signature 412 or points to it. The certificate 807 may have attributes such as start and end dates for validity and additional attributes, for example, the X.509 standard. The installer uses the public key 808 and an available decryption tool 812 to decrypt the encrypted hash value 810 and compare the clear text hash value 814 to a newly created hash value 822 of the file to be verified 816 or a directory to be verified.

Further discussing an example embodiment, and referring to FIGS. 3 and 8, the selected directory contains a directory signature file 310, 802 as opposed to a signature being appended to a file as in FIG. 1. The directory signature file 310, 802 contains multiple signatures, including one for each file in the selected directory being signed. For each file to be verified 816, its signature is extracted from the directory signature file 802. The signature includes the certificate identifier 804 used to retrieve the certificate 807 from the certificate store 806. The retrieved certificate 807 contains the public key 808. The signature also includes the encrypted hash value 810 for the file or assembly file, used by a decryption tool 812 along with the public key 808 to recover the clear text hash value 814 for the file to be verified 816. The signature also includes the hash identifier 818, used by an available hash creation tool 820 to recalculate the new hash value 822 for the file to be verified 816. If the file's new hash value 822 matches the clear text hash value 814, then it can be confirmed that the file to be verified 816 has not been modified, since it was originally signed, and the verification succeeds. If the new hash value does not match, then the verification fails.

The validity of the certificate 807 indicated by the certificate identifier 804 may be checked prior to using its public key 808. The certificate 807 may not be found in the certificate store 806 in which case the verification fails. The certificate 807 may have expired, may have been revoked, may have been superseded by another certificate, or otherwise been rendered invalid.

If the selected directory 300 to be signed contains file meta-data or sub-directory meta-data that the originator has chosen to be signed, those signatures appear in the directory signature file 802. The processing 800 uses the file meta-data or sub-directory meta-data in lieu of the file data 816 as input to the verification process.

To verify the directory signature file 310 itself, and referring to FIG. 7, follow the processing of FIG. 8 and use: items 702-744 concatenated into a string in lieu of file to be verified 816, item 702 for certificate identifier 804, item 704 for hash identifier 818, and item 746 for encrypted hash value 810. Other embodiments of directory signature files may be verified in a similar way using process 800 or variations thereof based on the present disclosure.

FIG. 9 illustrates a computer network 900 for obtaining access to software, directories, files, meta-data, and assemblies of files in a computing system according to one embodiment of the disclosure. The system 900 may include a server 902, a data storage device 906, a network 908, and a user interface device 910. The server 902 may also be a hypervisor-based system executing one or more guest partitions hosting operating systems with modules having server configuration information. In a further embodiment, the system 900 may include a storage controller 904, or a storage server configured to manage data communications between the data storage device 906 and the server 902 or other components in communication with the network 908. In an alternative embodiment, the storage controller 904 may be coupled to the network 908. In another embodiment, the network 900 may utilize virtual hardware and virtual machines which put a server 902, a data storage device 906, and a user interface device 910 on the internet (“the cloud”) and which may be expanded based on need.

In one embodiment, the user interface device 910 is referred to broadly and is intended to encompass a suitable processor-based device such as a desktop computer, a laptop computer, a personal digital assistant (PDA) or tablet computer, a smartphone or other mobile communication device having access to the network 908. In a further embodiment, the user interface device 910 may access the Internet or other wide area or local area network to access a web application or web service hosted by the server 902 and may provide a user interface for enabling a user to enter or receive information.

The network 908 may facilitate communications of data between the server 902 and the user interface device 910. The network 908 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

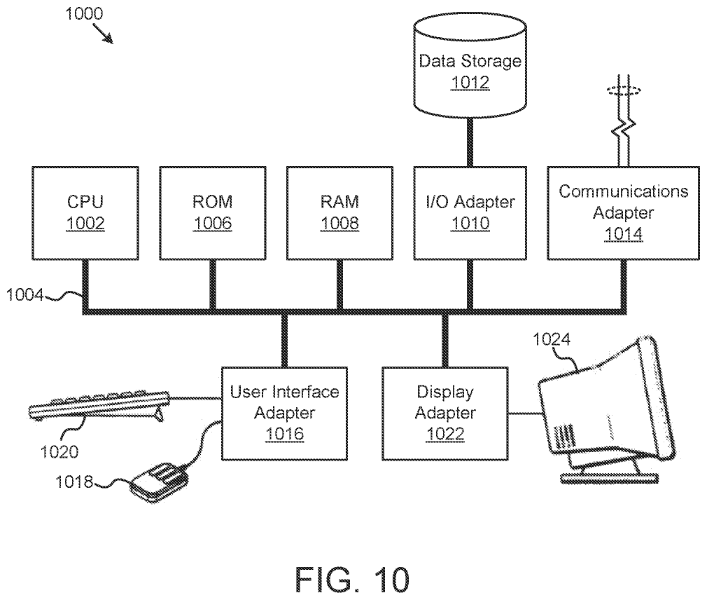

FIG. 10 illustrates a computer system 1000 adapted according to certain embodiments of the server 902 and/or the user interface device 910. The central processing unit (“CPU”) 1002 is coupled to the system bus 1004. The CPU 1002 may be a general purpose CPU or microprocessor, graphics processing unit (“GPU”), and/or microcontroller. The present embodiments are not restricted by the architecture of the CPU 1002 so long as the CPU 1002, whether directly or indirectly, supports the operations as described herein. The CPU 1002 may execute the various logical instructions according to the present embodiments.

The computer system 1000 may also include random access memory (RAM) 1008, which may be synchronous RAM (SRAM), dynamic RAM (DRAM), synchronous dynamic RAM (SDRAM), or the like. The computer system 1000 may utilize RAM 1008 to store the various data structures used by a software application. The computer system 1000 may also include read only memory (ROM) 1006 which may be PROM, EPROM, EEPROM, optical storage, or the like. The ROM may store configuration information for booting the computer system 1000. The RAM 1008 and the ROM 1006 hold user and system data, and both the RAM 1008 and the ROM 1006 may be randomly accessed.

The computer system 1000 may also include an 110 adapter 1010, a communications adapter 1014, a user interface adapter 1016, and a display adapter 1022. The I/O adapter 1010 and/or the user interface adapter 1016 may, in certain embodiments, enable a user to interact with the computer system 1000. In a further embodiment, the display adapter 1022 may display a graphical user interface (GUI) associated with a software or web-based application on a display device 1024, such as a monitor or touch screen.

The I/O adapter 1010 may couple one or more storage devices 1012, such as one or more of a hard drive, a solid state storage device, a flash drive, a compact disc (CD) drive, a floppy disk drive, and a tape drive, to the computer system 1000. According to one embodiment, the data storage 1012 may be a separate server coupled to the computer system 1000 through a network connection to the I/O adapter 1010. The communications adapter 1014 may be adapted to couple the computer system 1000 to the network 908, which may be one or more of a LAN, WAN, and/or the Internet. The user interface adapter 1016 couples user input devices, such as a keyboard 1020, a pointing device 1018, and/or a touch screen (not shown) to the computer system 1000. The display adapter 1022 may be driven by the CPU 1002 to control the display on the display device 1024. Any of the devices 1002-1022 may be physical and/or logical.

The applications of the present disclosure are not limited to the architecture of computer system 1000. Rather the computer system 1000 is provided as an example of one type of computing device that may be adapted to perform the functions of the server 902 and/or the user interface device 1010. For example, any suitable processor-based device may be utilized including, without limitation, IoT devices, tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, solid-state storage, flash memory, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Generally, solid-state storage use electronic circuits to reproduce data, including flash memory. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

The disclosed system and methods allow for benefits in any hierarchical file system or flat file system. As one example, the invention allows an originator to sign non-executable files and non-assembled files including, for example, configuration text files, read.me text files, structured files such as MP3 audio files or MP4 video files, and other types of files for which no signing process previously exists. As another embodiment, an originator may create unique signatures for each file in a directory or for each sub-directory of files, regardless of the file type or its contents.

Additionally, the disclosed invention allows an originator to differentiate among the various kinds or purposes of the files, for example, files which can be executed, files which contain configuration information, and files which are documentation, e.g. read.me, files by creating a separate signature for each file or kind or purpose of file. This same separate distinction can be implemented to distinguish various kinds and purposes of sub-directories, for example, sub-directories containing the same types of files described above for types of files. An originator may even create a separate signature for each file, each sub-directory, each kind of file, or each kind of sub-directory in given directory.

Further, the invention allows for signing meta-data. An originator using the invention may create a signature for the meta-data characteristics of each file, or a set of files, or for the meta-data characteristics of each sub-directory of files. This allows verification and detection of changes in the files or in the meta-data. Further, the invention allows for signing sub-directories as discussed.

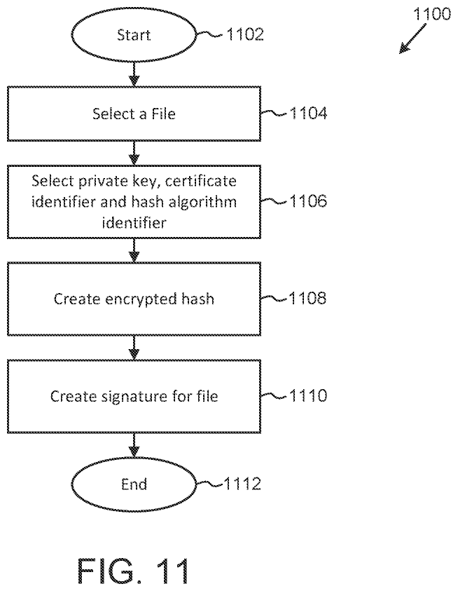

FIG. 11 is a flow diagram of a method 1100 for securing files through a persistent signature. The method 1100 starts at 1102. At 1104 a file of any type is selected. The file type could be an executable file or another file type such as configuration files, scripts, MP3, MP4, or descriptive text files. Whether the file type is human-readable or encoded in a non-human readable structured form does not matter as the method 1100 can be used with either types. At 1106, a private key, certificate identifier and a hash algorithm identifier are selected for the file. At 1108, an encrypted hash of the file selected is created with the hash algorithm and private key selected for the file at 1106.

The private key will most often have a unique public key paired to it which can be identified with the certificate identifier selected at 1106. At 1110, a persistent, independent signature for each selected file that identifies the file, certificate identifier, hash identifier and the encrypted hash value for the file is created. The method 1100 ends at 1112. This signature can be stored in a variety of forms, including being stored in a directory for a group or set of files, which may be accessed by a user or may be made part of an automated verification system. The signature may be displayed or accessed and processed as human-readable or machine-readable text and numerals. The signature may be created so that files with similar qualities share characteristics, such as sharing the same private key. Software originators and vendors can apply a signature created with method 1100 to any file type and may group files for related applications or keep every file uniquely signed.

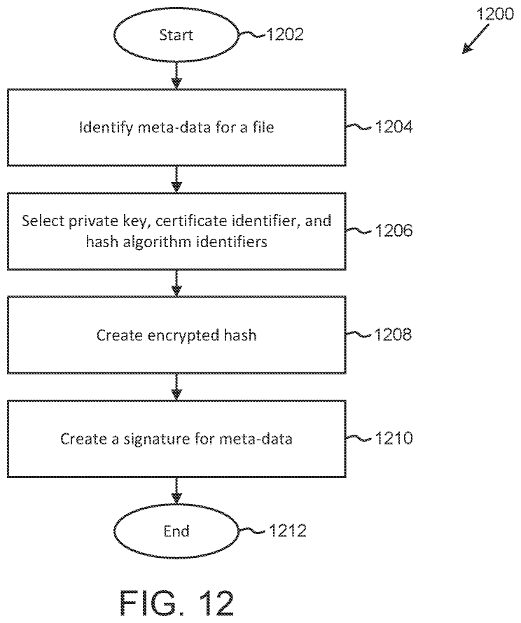

FIG. 12 is a flow diagram of a method 1200 for securing files through a persistent signature for file meta-data. The method 1200 starts at 1202. At 1204 meta-data for a file is identified. Each kind of file system creates and maintains different meta-data about its files and directories. Meta-data attributes of files may be freely created or changed by users while others can only be created or changed by a file system. The meta-data set created or changed by the file system is generally more restricted as some such data is created when the file is created, or only the creator or a privileged user may alter it. Easily changeable meta-data includes things like the name of the file; name of the directory; read, write, or execute restricted access to a file; read or write restricted access to a directory; a list of users, roles, or other characteristics who can perform the restricted access to a file or directory, sometimes maintained as an “Access Control List,” whether a file is an executable file or not. For meta-data set created or changed by the file system itself or privileged users, examples are timestamps: for creation, last reference, last modification, last backup, and others. Some file systems set a meta-data attribute to indicate a file is executable when the file is created. Some file systems set the read, write, and execute meta-data attributes at file creation time. These meta-data attributes are generally unalterable or only changeable by the creator or similarly privileged user.

Certain meta-data or all available meta-data may be identified for method 1200. Some meta-data changes can have significant impact on a product and its security. For example, changing the executable attribute of a file can make it unusable or can make a previously non-executable file into a malicious executable. Adding a write access meta-data attribute to a file or directory immediately compromises its security. At 1206, a private key, certificate identifier and a hash algorithm identifier are selected for the meta-data identified. At 1208, an encrypted hash of the meta-data is created with the hash algorithm and private key selected for the meta-data at 1206. At 1210, a persistent, independent signature for the meta-data that identifies the meta-data, certificate identifier, hash identifier and the encrypted hash value for the meta-data is created. The meta-data may be identified as pertaining to one file, a group of files, all meta-data for a file, or select meta-data chosen to be secured. The method 1200 ends at 1212. By creating a signature for meta-data, the method 1200 can allow for detection if any meta-data attributes have been changed since the signature was created at 1210, ensuring security to a higher level than prior signature and certificate systems.

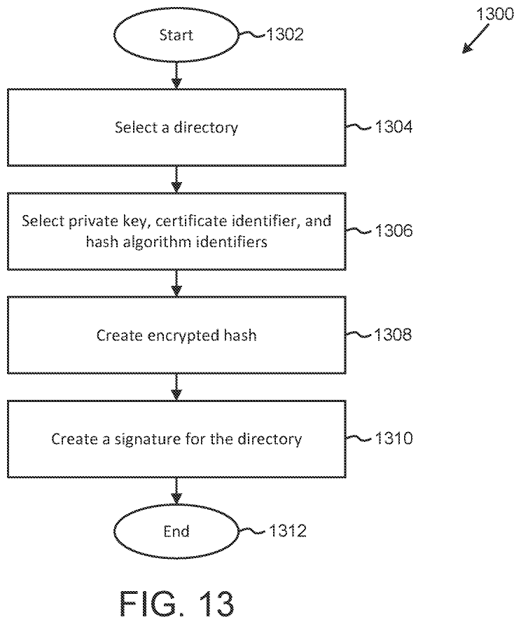

FIG. 13 is a flow diagram of a method 1300 for securing directories or sub-directories through a persistent signature for the directory. The method 1300 starts at 1302. At 1304 a directory is selected. A directory may be a sub-directory, and may contain files and nested sub-directories of various types. At 1306 a private key, certificate identifier and a hash algorithm identifier are selected for the directory. This step may be repeated if method 1300 is carried out for more than one sub-directory in the directory, or if a user carrying out method 1300 desires to also use method 1100 to create signatures for files contained in the selected directory. At 1308, an encrypted hash of the directory selected is created with the hash algorithm and private key selected for the directory at 1306. The encrypted hash may be of an aggregate of the directory's content or a concatenated string representing signatures of the directory's content created using method 1100 (FIG. 11) or method 1200 (FIG. 12), or other representation of the directory's content.

The private key will most often have a unique public key paired to it which can be identified with the certificate identifier selected at 1306. At 1310, a persistent, independent signature for the directory that identifies the directory and its contents, certificate identifier, hash identifier and the encrypted hash value for the directory is created. The method 1300 ends at 1312.

Additionally, the method 1200 (FIG. 12) may be used to create a signature for the meta-data of a directory signed with the method 1300 (FIG. 13) and the signatures may be unique from each other or may share characteristics.

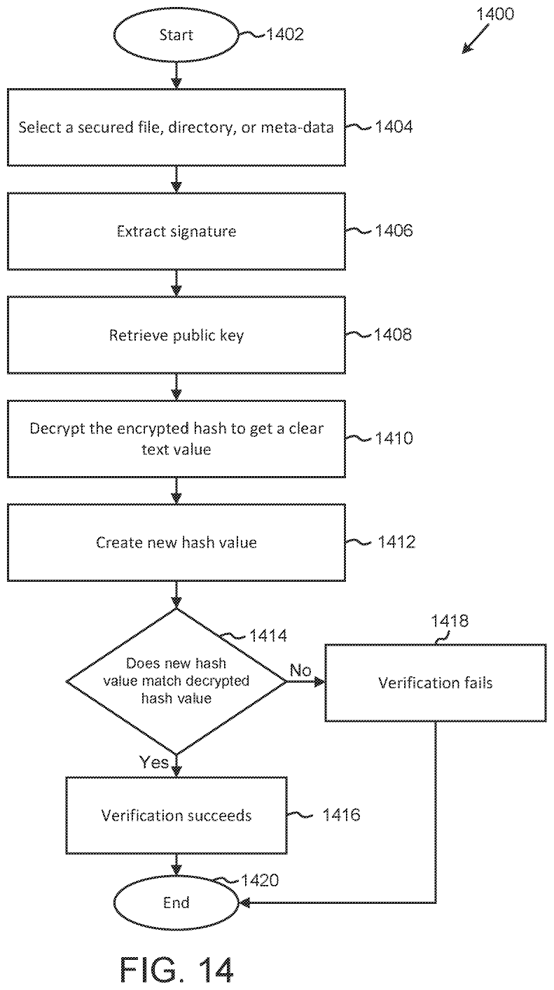

FIG. 14 is a method 1400 for verifying a secured file, directory, or meta-data. The method 1400 starts at 1402. At 1404 a secured file, directory, or meta-data is selected to process with method 1400. At 1406 a persistent, independent signature for the selected secured file, directory, or meta-data is obtained or extracted from a directory signature file. The signature includes a certificate identifier and at 1408 is used to retrieve a certificate, for example from a user's certificate store, and obtain a public key. The signature also includes the encrypted hash value for the file, directory, or meta-data, and at 1410 this encrypted hash value is decrypted using the public key and a decryption tool, creating a clear text hash value from the signature. Next, at 1412 the signature's hash identifier and a hash creation tool are used to create a new hash value for the file, directory, or meta-data. Then, at 1414 the decrypted hash value from 1410 is compared with the new hash value created at 1412. A decision is made at 1414 depending on if the hash values match. If the file's new hash value matches the clear text hash value, then it can be confirmed that the file, directory, or meta-data to be verified has not been modified since it was originally signed, and the verification succeeds at 1416. If the new hash value does not match, then the verification fails at 1418. The method 1400 ends at 1420.

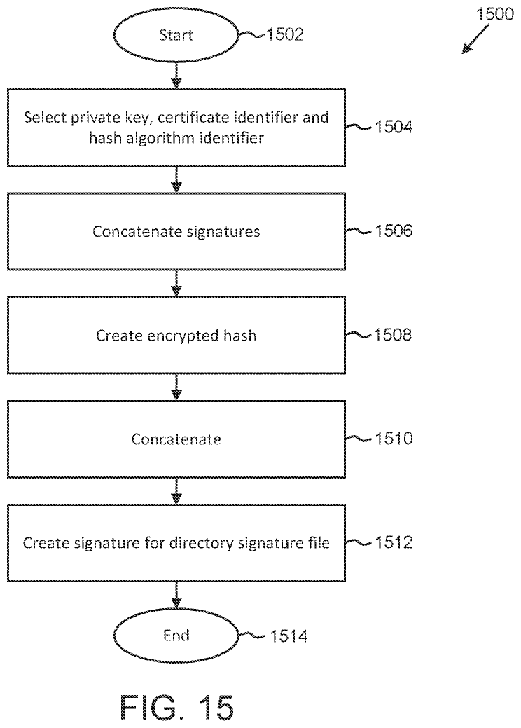

FIG. 15 is a method 1500 for creating a persistent directory signature file. Method 1500 starts at 1502. At 1504 a private key, a certificate identifier and a hash algorithm identifier for the directory signature file are selected. At 1506 one or more persistent, independent signatures to be included in the directory are concatenated. The persistent independent signatures include a file name, sub-directory indicator, or meta-data indicator, and a certificate identifier, and a hash identifier, and an encrypted hash. At 1508 an encrypted hash of the one or more concatenated signatures is created using the hash algorithm and private key chosen for the directory signature file. At 1510 the encrypted hash of the one or more concatenated signatures is concatenated with the concatenated signatures and the certificate identifier, and hash algorithm identifier chosen for the directory signature file. At 1512 the concatenation from 1510 is used to create a persistent, independent signature for the directory signature file. The method 1500 ends at 1514.

The directory signature file created using method 1500 can be verified itself because it has a signature and the elements of a signature to be verified using method 1400 (FIG. 14). It also may be used to verify any of its contents since it also contains the signatures and elements needed for method 1400.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A processor-based method for creating a persistent directory signature file, comprising:
selecting a private key, a certificate identifier and a hash algorithm identifier for the directory signature file;
concatenating one or more persistent, independent signatures wherein a persistent independent signature includes a file name, sub-directory indicator, or meta-data indicator, and a certificate identifier, and a hash identifier, and an encrypted hash;
creating an encrypted hash of the one or more concatenated signatures using the hash algorithm and private key chosen for the directory signature file; and
concatenating the encrypted hash of the one or more concatenated signatures with the concatenated signatures and the certificate identifier, and hash algorithm identifier chosen for the directory signature file to create a persistent, independent signature for the directory signature file.

2. The method of claim 1, wherein any sub-directory included is assembled into a file and a signature is created for it before concatenating the encrypted hash.

3. The method of claim 1, wherein any sub-directory included has a directory signature file created for it before concatenating the encrypted hash.

4. The method of claim 1, wherein the persistent directory signature file includes one or more file of more than one type.

5. The method of claim 1, wherein the persistent directory signature file includes one or more files and meta-data for the files.

6. The method of claim 1, wherein the persistent directory signature file includes meta-data for the directories.

7. A computer program product, comprising:
a non-transitory computer readable medium comprising instructions which, when executed by a processor of a computing system, cause the processor to perform the steps of:
selecting a private key, a certificate identifier and a hash algorithm identifier for the directory signature file;
concatenating one or more persistent, independent signatures wherein a persistent independent signature includes a file name, sub-directory indicator, or meta-data indicator, and a certificate identifier, and a hash identifier, and an encrypted hash;
creating an encrypted hash of the one or more concatenated signatures using the hash algorithm and private key chosen for the directory signature file; and
concatenating the encrypted hash of the one or more concatenated signatures with the concatenated signatures and the certificate identifier, and hash algorithm identifier chosen for the directory signature file to create a persistent, independent signature for the directory signature file.

8. The computer program product of claim 7, wherein any sub-directory included is assembled into a file and a signature is created for it before concatenating the encrypted hash.

9. The computer program product of claim 7, wherein any sub-directory included has a directory signature file created for it before concatenating the encrypted hash.

10. The computer program product of claim 7, wherein the persistent directory signature file includes one or more file of more than one type.

11. The computer program product of claim 7, wherein the persistent directory signature file includes one or more files and meta-data for the files.

12. The computer program product of claim 7, wherein the persistent directory signature file includes meta-data for the directories.

13. A persistent directory signature file comprising:
a directory signature file certificate identifier;
a directory signature file hash identifier;
a file name;
a file certificate identifier;
a file hash identifier;
a file hash value encrypted; and
a directory signature file hash value encrypted.

14. The persistent directory signature file of claim 13, wherein the directory comprises one or more files of more than one file type.

15. The persistent directory signature file of claim 13, further comprising meta-data for a file.

16. The persistent directory signature file of claim 15, further comprising meta-data for a plurality of files.

17. The persistent directory signature file of claim 16, wherein the plurality of file includes files of more than one file type.

18. The persistent directory signature file of claim 17, wherein a file type includes an executable file.

19. The persistent directory signature file of claim 13, further comprising meta-data for a directory.

20. The persistent directory signature file of claim 16, further comprising meta-data for a plurality of directories or sub-directories.
